(19) United States
(12) Patent Application Publication
(10) Pub. No.: US 2019/0377656 A1
(43) Pub. Date: Dec. 12, 2019

(54) Integrated Management System for Container-Based Cloud Servers

(71) Applicant: TmaxOS Co., Ltd., Seongnam-si (KR)

(72) Inventors: Junmin Choe, Seoul (KR); Hyunsuk Moon, Seongnam-si (KR)

(21) Appl. No.: 16/054,130

(22) Filed: Aug. 3, 2018

(30) Foreign Application Priority Data
Jun. 11, 2018 (KR) 10-2018-0066644

(51) Int. Cl. G06F 11/34; G06F 9/54; G06F 9/50; G06F 9/455

(52) U.S. Cl. CPC G06F 11/3495; G06F 9/542; G06F 9/5072; G06F 9/5077; G06F 2009/45591; G06F 9/45558; G06F 2201/86; G06F 2201/875; G06F 11/3409

(57) ABSTRACT

Disclosed is a method for monitoring and controlling a container-based cloud server. In a computer program stored in a computer-readable storage medium, including encoded commands, which causes one or more processors to perform operations for monitoring respective containers operating in a container-based cloud server when the computer program is executed by the one or more processors of a computer system, the operations including: an operation of monitoring static resource information from a host OS; an operation of monitoring container information of each of a plurality of containers from the host OS; an operation of determining whether a predetermined event occurs; an operation of driving an event processing module corresponding to an event which occurs among a plurality of event processing modules when an event occurs based on the determination as to whether the event occurs; and an operation of performing a predetermined operation by using the driven event processing module.

### CROSS-REFERENCE TO RELATED APPLICATIONS

This application claims priority to and the benefit of Korean Patent Application No. 10-2018-0066644 filed in the Korean Intellectual Property Office on Jun. 11, 2018, the entire contents of which are incorporated herein by reference.

### TECHNICAL FIELD

The present disclosure relates to an integrated management system, and more particularly, to an integrated management system for container-based cloud servers.

### BACKGROUND ART

The existing computing environment which relies on independent hardware performance of each terminal according to technological development of a computer network has evolved to a cloud computing type that utilizes all computing resources on a network and provides a corresponding service to be simply and easily used according to a request of a user terminal. Currently, cloud computing technology is widely used in server and system configuration due to an advantage that IT resources can be shared with each other and idle resources can be efficiently used when constructing an IT infrastructure. Virtualization technology is one of the core based technologies of cloud computing and open server virtualization technologies that are widely used in a server field include Xen, KVM, VirtualBox, and so on, which are called a virtual machine (VM) or hypervisor basis. Virtual machine-based server virtualization technology is a scheme that installs an operating system (hereinafter, referred to as a host OS) on a physical server, creates a virtual machine by dividing resources based on the hypervisor, and then installs an operating system (hereinafter referred to as a guest OS) and drive a desired application program again. Such a scheme has an advantage in that multiple servers independently operable can be provided in one physical system, but has a disadvantage in that when the host OS and the guest OS are operating in the same operating system, the waste of resources is large.

Accordingly, in recent years, a container scheme, which is a virtualization technology of a different scheme from the virtual machine scheme, is popular. The container-based system is much lighter than the virtual machine scheme because the container-based system shares an operating system kernel, and as a result, the container-based system has better mobility, faster startup times, and occupies much less memory than full booting of the operating system. In such a cloud service environment, virtual machine servers and resources are selected and used as many as desired at a desired time through a cloud system in which required resources including a CPU, a memory, a storage, an application program, and the like are provided by a virtual technology, and as a result, high economical efficiency and expandability and advanced services can be provided, but there are problems such as security, stability and guarantee of service performance. In addition to providing economical and efficient services compared to the existing systems, performance of the existing systems should be guaranteed to the same level in the cloud and data and materials to objectively assure the performance are required.

Accordingly, there is a demand in the art for an integrated management system that performs performance information management, real-time resource monitoring, and server control to identify the performance and problems of container-based cloud servers.

### SUMMARY OF THE INVENTION

The present disclosure has been made in an effort to provide an integrated management system for container-based cloud servers.

An exemplary embodiment of the present disclosure provides a computer program stored in a computer-readable storage medium, including encoded commands, which causes one or more processors to perform the following operations for monitoring respective containers operating in a container-based cloud server when the computer program is executed by the one or more processors of a computer system, in which the operations may include: an operation of monitoring static resource information from a host OS; an operation of monitoring container information of each of a plurality of containers from the host OS; an operation of determining whether a predetermined event occurs; an operation of driving an event processing module corresponding to an event which occurs among a plurality of event processing modules when an event occurs based on the determination as to whether the event occurs; and an operation of performing a predetermined operation by using the driven event processing module.

Alternatively, the static resource information may include basic information for constructing the container-based cloud server.

Alternatively, the container information may include dynamic resource information and basic container information, and the dynamic resource information may include information on a resource usage for each of a plurality of containers and a resource remaining amount of the cloud server as information on a resource which is changed in real time and the basic container information may include at least one of information on an application operation for each container among the plurality of containers and information on the operation of the user.

Alternatively, the plurality of event processing modules may include at least one of a static resource monitoring module, a dynamic resource monitoring module, a basic container information monitoring module, and a container control module.

Alternatively, the predetermined event may include at least one of an event for dynamic resource variation, an event based on a comparison of the basic container information and action criterion information, an event for container control, an event for a container information request, and an event for a time period.

Alternatively, the event for the dynamic resource variation may be an event related to a resource usage variation of each of the plurality of containers, and when the dynamic resource variation occurs, the processor may operate a dynamic resource monitoring module and the dynamic resource monitoring module may perform operations of collecting dynamic resource information of at least one container among the plurality of containers connected to the host OS, and transmitting the collected dynamic resource information to the management server.

Alternatively, the event based on the comparison of the basic container information and the action criterion information may be an event regarding whether the user of the container-based cloud server violates the preset action criterion information and the processor may operate the basic container information monitoring module based on the comparison between the action criterion information received from the management server and the basic container information and the basic container information monitoring module may perform operations of collecting the basic container information of at least one container among the plurality of containers connected to the host OS and transmitting the collected basic container information to the management server.

Alternatively, the event for the container control may be an event for controlling the plurality of containers connected to the container-based cloud server and may be generated based on the control information received from the management server and the processor may operate the container control module when receiving the control information from the management server and the container control module may perform at least one operation of a device control operation, a file control operation, a program control operation, a process control operation, and a network control operation of at least one container among the plurality of containers connected to the host OS.

Alternatively, the event for the container information request is an event related to the request of the administrator for the container information and the processor may operate at least one module of the dynamic resource monitoring module and the basic container information monitoring module when receiving the request information from the management server.

Alternatively, the event for the time period may be an event that occurs at a predetermined time period that is repeated and the processor may operate at least one module of the static resource monitoring module, the dynamic resource monitoring module, the basic container information monitoring module, and the container control module according to the predetermined time period.

Another exemplary embodiment of the present disclosure provides a method for monitoring respective containers operating a container-based cloud server, including: monitoring static resource information from a host OS; monitoring container information of each of a plurality of containers from the host OS; determining whether a predetermined event occurs; driving an event processing module corresponding to an event which occurs among a plurality of event processing modules when an event occurs based on the determination as to whether the event occurs; and performing a predetermined operation by using the driven event processing module.

Yet another exemplary embodiment of the present discloses a container-based cloud server. The server may include: a processor including one or more cores; a memory storing program codes executed by the processor; and a network unit transmitting/receiving data to/from a management server, and the processor may perform operations for monitoring respective containers operating in the container-based cloud server and the operations may include an operation of monitoring static resource information from a host OS; an operation of monitoring container information of each of a plurality of containers from the host OS; an operation of determining whether a predetermined event occurs; an operation of driving an event processing module corresponding to an event which occurs among a plurality of event processing modules when an event occurs based on the determination as to whether the event occurs; and an operation of performing a predetermined operation by using the driven event processing module.

Still yet another exemplary embodiment of the present disclosure provides a computer program stored in a computer-readable storage medium, including encoded commands, which causes one or more processors to perform the following operations for integratedly managing a container-based cloud server when the computer program is executed by the one or more processors of a computer system, in which the operations may include: an operation of receiving static resource information and container information from the container-based cloud server; an operation of generating integrated information by integrating the received static resource information and container information; an operation of generating a user interface to be provided to an external computing device based on the integrated information; and an operation of generating request information and control information based on a selection input for the user interface from the external computing device.

Alternatively, the operation for integratedly managing the container-based cloud server may further include an operation of deciding to transmit the request information and the control information to the container-based cloud server.

Alternatively, the request information may be information on a request of an administrator for the container-based cloud server and may be a request for at least one information of dynamic resource information and basic container information.

Alternatively, the control information may be information for controlling the container-based cloud server and may be generated by setting of the administrator.

Alternatively, the user interface may be additionally provided to the external computing device, including information on an importance of an event which occurs in the container-based cloud server and provided to the external computing device, including information on a resource usage for each time zone of each container of the container-based cloud server.

Still yet another exemplary embodiment of the present disclosure provides a method for integratedly managing a container-based cloud server, including: receiving static resource information and container information from the container-based cloud server; generating integrated information by integrating the received static resource information and container information; generating a user interface to be provided to an external computing device based on the integrated information; and generating request information and control information based on a selection input for the user interface from the external computing device.

Still yet another exemplary embodiment of the present disclosure provides a management server providing an integrated management service, including: a processor including one or more cores; a memory storing program codes executed by the processor; and a network unit transmitting/receiving data to/from the management server, and the processor may perform operations for integratedly managing the container-based cloud server and the operations may include an operation of receiving static resource information and container information from the container-based cloud server; an operation of generating integrated information by integrating the received static resource information and container information; an operation of generating a user interface to be provided to an external computing device based on the integrated information; and an operation of generating request information and control information based on a selection input for the user interface from the external computing device.

According to an exemplary embodiment of the present disclosure, an integrated management system for container-based cloud servers can be provided.

### BRIEF DESCRIPTION OF THE DRAWINGS

Various aspects are now described with reference to the drawings and like reference numerals are generally used to designate like elements. In the following exemplary embodiments, for a purpose of description, multiple specific detailed matters are presented to provide general understanding of one or more aspects. However, it will be apparent that the aspect(s) can be executed without the detailed matters.

FIG. 1 is a conceptual diagram illustrating an overall system of a management server providing an integrated management service to container-based cloud servers according to an exemplary embodiment of the present disclosure.

FIG. 2 illustrates an exemplary view of a container environment for constructing container-based cloud servers according to an exemplary embodiment of the present disclosure.

FIG. 3 is a block diagram of container-based cloud servers according to an exemplary embodiment of the present disclosure.

FIG. 4 is a flowchart of an operation for processors of container-based cloud servers to monitor respective containers according to an exemplary embodiment of the present disclosure.

FIG. 5 is a detailed configuration diagram of an agent installed in a host OS according to an exemplary embodiment of the present disclosure.

FIG. 6 is a diagram illustrating a means for monitoring respective containers which operate in container-based cloud servers according to an exemplary embodiment of the present disclosure.

FIG. 7 is a diagram illustrating modules for monitoring respective containers which operate in container-based cloud servers according to an exemplary embodiment of the present disclosure.

FIG. 8 is a diagram illustrating logics for monitoring respective containers which operate in container-based cloud servers according to an exemplary embodiment of the present disclosure.

FIG. 9 is a diagram illustrating circuits for monitoring respective containers which operate in container-based cloud servers according to an exemplary embodiment of the present disclosure.

FIG. 10 is a block diagram of a management server according to an exemplary embodiment of the present disclosure.

FIG. 11 is a flowchart of an operation of a management server processor included in a management server, for integratedly managing container-based cloud servers according to an exemplary embodiment of the present disclosure.

FIG. 12 is an exemplary view of a Dashboard user interface which a management server provides to an external computing device according to an exemplary embodiment of the present disclosure.

FIG. 13 is an exemplary view of an Event History user interface which the management server provides to the external computing device according to an exemplary embodiment of the present disclosure.

FIG. 14 is an exemplary view of an Inventory user interface which the management server provides to the external computing device according to an exemplary embodiment of the present disclosure.

FIG. 15 is an exemplary view of a Command History user interface which the management server provides to the external computing device according to an exemplary embodiment of the present disclosure.

FIG. 16 is an exemplary view of a Policy user interface which the management server provides to the external computing device according to an exemplary embodiment of the present disclosure.

FIG. 17 is a diagram illustrating means for a processor included in a management server to integratedly manage container-based cloud servers according to an exemplary embodiment of the present disclosure.

FIG. 18 is a diagram illustrating modules for the processor included in the management server to integratedly manage the container-based cloud servers according to an exemplary embodiment of the present disclosure.

FIG. 19 is a diagram illustrating a logic for the processor included in the management server to integratedly manage the container-based cloud servers according to an exemplary embodiment of the present disclosure.

FIG. 20 is a diagram illustrating a circuit for the processor included in the management server to integratedly manage the container-based cloud servers according to an exemplary embodiment of the present disclosure.

FIG. 21 is a simple and general schematic view of an exemplary computing environment in which exemplary embodiments of the present disclosure may be implemented.

### DETAILED DESCRIPTION

Various exemplary embodiments will now be described with reference to drawings and like reference numerals are used to refer to like elements throughout all drawings. In the present specification, various descriptions are presented to provide appreciation of the present disclosure. However, it is apparent that the exemplary embodiments can be executed without the specific description. In other examples, known structures and apparatuses are presented in a block diagram form in order to facilitate description of the exemplary embodiments.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside in the processor and/or the execution thread and one component may be localized in one computer or distributed among two or more computers. Further, the components may be executed by various computer-readable media having various data structures, which are stored therein. The components may perform communication with another system through local and/or remote processing according to a signal (for example, data from one component that interacts with other components and/or data from other systems through a network such as the Internet through a signal in a local system and a distribution system) having one or more data packets, for example.

It should be appreciated that the word “comprises” and/or “comprising” means that the corresponding feature and/or component is present, but presence or addition of one or more other features, components, and/or a group thereof is not excluded. Further, when not separately specified or not clear in terms of the context that a singular form is indicated, it should be construed that the singular form generally means “one or more” in the present specification and the claims.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

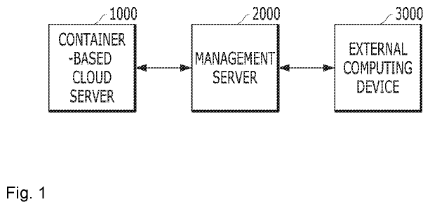

FIG. 1 is a conceptual diagram illustrating an overall system of a management server 2000 providing an integrated management service to container-based cloud servers 1000 according to an exemplary embodiment of the present disclosure.

According to an exemplary embodiment of the present disclosure, the container-based cloud server 1000, the management server 2000, and an external computing device 3000 may transmit and receive information through wired and/or wireless interconnection.

According to an exemplary embodiment of the present disclosure, the container-based cloud server 1000 may collect information from each container located in the container-based cloud server 1000. Further, the container-based cloud server 1000 may transmit the collected information to the management server 2000. In this case, the management server 2000 may generate a user interface for integrated management including observation of a resource usage and user control of the container-based cloud server 1000 based on the information received from the container-based cloud server 1000. Accordingly, the management server 2000 may generate a user interface capable of observing and/or controlling the container-based cloud server 1000 and providing the user interface to an administrator terminal, that is, the external computing device 3000.

According to an exemplary embodiment of the present disclosure, the container-based cloud server 1000 may monitor and collect container information on each of a plurality of containers included in the container-based cloud server 1000 and transmit the monitored and collected container information to the management server 2000. In this case, the container information may include dynamic resource information and basic container information. The dynamic resource information included in the container information as information on a resource that changes in real time may include information on a resource usage of each of the plurality of containers connected to a host operating system (OS) 1002 and a resource remaining amount of the cloud server. Specifically, the dynamic resource information may be information on a change amount of a resource used for driving an application in the plurality of containers. For example, the dynamic resource information may include information on a utilization rate and a usage time of a CPU, a memory, a hard disk, or a network, which are changed when a user of the container-based cloud server operates the application. In addition, the basic container information included in the container information may include at least one of information on an application operation for each container and information on the operation of the user. Specifically, the basic container information may include information that the application executed in at least one container among the plurality of containers connected to the host OS 1002 is changed based on at least one of an installation action, a deletion action, and a removal deletion of the user. As a specific example, the basic container information may include information that the application is changed by at least one of the installation action, the deletion action, a change action, a connection action, a release action, and an access action of the user for a file, a program, a process, a device, a network and a shared directory operated in the application. The concrete description of the dynamic resource information and basic container information is only an example and the present disclosure is not limited thereto.

According to an exemplary embodiment of the present disclosure, the container-based cloud server 1000 monitors the basic container information from the plurality of containers to detect the action of the user using the container-based cloud server 1000. Specifically, the container-based cloud server 1000 may receive action criteria information, which is a definition of a user restriction action set by the management server 2000 and determine whether the user using the container-based cloud server 1000 performs the restriction action through comparison of the action criterion information and the basic container information monitored from the plurality of containers.

According to an exemplary embodiment of the present disclosure, the container-based cloud server 1000 may monitor static resource information of the container-based cloud server 1000 and transmit the monitored container information to the management server 2000.

In this case, the static resource information may include basic information for constructing the container-based cloud server 1000. Specifically, the static resource information may include information on hardware, software, and the network constructing the container-based cloud server 1000. For example, the information on the hardware may include information on at least one of the CPU, the memory, a disk, a LAN card, a graphics card, and a monitor. In another example, the information on the network may include at least one of Host name information, Interface name information, MAC address information, Netmask information, gateway information, and DNS information. The concrete description of the static resource information is only an example and the present disclosure is not limited thereto.

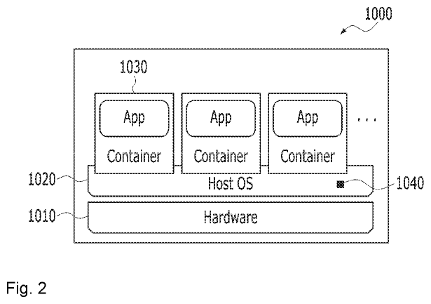

According to an exemplary embodiment of the present disclosure, the container-based cloud server 1000 may monitor and collect the container information of each of the plurality of containers through an agent 1040 installed in the host operating system (OS) 1002. The host OS may include an operating system for operating the cloud server 1000 and may include Windows, Linux, Unix, Tmax OS, iOS, Android, etc., and the description of the host OS described above is merely an example, but the present disclosure may include a predetermined operating system. As illustrated in FIG. 2, the container-based cloud server 1000 may include hardware 1010 for constructing the container-based cloud server 1000. In this case, the hardware 1010 may include all physical components (devices) for constructing the cloud server and implement at least one function of input, calculation, control, storage, and output. For example, the hardware 1010 may include a central processing unit (CPU), a random access memory (RAM), a graphics card, a hard disk drive (HDD), and the like. The container-based cloud server 1000 may virtualize an OS environment itself such that each container has a unique isolated space thereof so as to execute the plurality of containers in the host OS 1002 provided in the hardware 1010. Therefore, each of the containers may be allocated resources such as the CPU, the RAM, a file system, a storage, or the network through the host OS and independently execute the application 1030.

According to an exemplary embodiment of the present disclosure, an agent 1040 may be installed in the host OS 1002 of the container-based cloud server 1000. The agent 1040 is installed in the host OS 1002 and monitors each of the plurality of containers connected to the host OS 1002 to collect at least one (for example, the CPU, the memory, the disk (storage), the software (usage time, frequency), the network (bandwidth, usage time zone, port open), etc., as the static resource information and file (modification/deletion), program (installation/removal), process (execution/end), device (USB connection/disconnection), etc., as the container information) of the static resource information and the container information.

In one example of implementation of the present disclosure, the host OS of the container-based cloud server 1000 may be, for example, Linux. Accordingly, in the container-based cloud server 1000, cgroups (control groups) of a Linux kernel may be used. The cgroups is the Linux kernel that groups each of the processes executed in the plurality of containers of the container-based cloud server 1000 and isolates and divides the processes so as to measure the usage of system resources (CPU, memory, disk I/O network, etc.) of the process belonging to the corresponding group. In one example of the implementation of the present disclosure, the container-based cloud server 1000 may monitor the information on the resource usage by reading a file by accessing a cgroups file system instead of calling a separate system library through the cgroups to monitor the resource usage through the cgroups. Hereinafter, the method for monitoring the resource usage by using the cgroups of the Linux kernel will be described in detail.

According to an exemplary embodiment of the present disclosure, the cloud server 1000 may monitor the memory usage of a specific container using the cgroups of the Linux kernel. For example, a command to monitor the memory usage of the specific container is as follows.

“/sys/fs/cgroup/memory/lxc/10b0fb69677ef5e42cd8dc817b452e17910 4145a0216 b6cb010c8ac0a9351208/memory.stat”

In this case, “10b0fb69677ef5e42cd8dc817b452e179104145a0216b6cb010c8ac0a9351208” included in the command may be a unique ID of the container.

The following result value may be obtained through input of such a command.

“total_cache 110592, total_rss 21177139”

In this case, total_rss among values output as the result may indicate the memory usage. Specifically, the cloud server 1000 may know that the specific container uses memory of 211771392 bytes, that is, approximately memory of 202 MB. Accordingly, the cloud server 1000 may monitor the resource for each of the containers (process group) among the plurality of containers using the cgroups of the Linux kernel. The specific command relating to the above-mentioned memory is only an example and the present disclosure is not limited thereto.

In the cloud server 1000 using Linux as the host OS, command lxc-info may be provided to ordinary users in order to conveniently and easily display resource information for each container without understanding the file system. Specifically, the command lxc-info may serve to directly parse contents of a resource information file located in /sys/fs/cgroup and summarize and output the contents so that the ordinary users may understand the contents even though the ordinary users do not deeply understand system terminologies. For example, when “lxc-info- n webserver” is input, the resource of a container having a name of “webserver” is monitored to show a state of the corresponding container, a process ID, an IP address, a CPU usage, a memory usage, and the like as outputs. In addition to the above-described lxc-info, commands that may easily perform container creation/removal and management may be provided. The description of the aforementioned commands is just an example and the present disclosure is not limited thereto.

According to an exemplary embodiment of the present disclosure, the container-based cloud server 1000 may perform a plurality of control operations for the plurality of containers. Specifically, at least one of a device control operation, a file control operation, a program control operation, a process control operation, and a network control operation of at least one of the plurality of containers connected to the host OS 1020 may be performed. For example, when performing control to restrict the total CPU usage of the container-based cloud server 1000 to less than 50%, the agent 1040 located in the host OS 1020 may send a restriction request to each container actually using the resource. In this case, basically, since the container has no restriction in the resource usage, the resource may be used as many as a scheduler of the host OS 1020 allows. Accordingly, the processor may issue a command for the restriction to each container through the kernel for restricting the resource usage of each container and each container performs an operation (the CPU total usage is restricted to less than 50%) for the command and thereafter, transmit notification information to the agent 1040. Upon receiving the notification, the agent 1040 transmits information on the execution completion of the operation to the management server 2000 and ends the operation for a control request. More specifically, the restriction of the CPU and/or memory usage may be transferred to each container from the host OS 1020 via the command. For example, when the following cgroups command is executed, the maximum memory usage of the container having the name of “webserver” may be restricted to 2 MB. “$echo 2000000>/sys/fs/cgroups/memory/webserver/memory.kmem.limit_inbytes”

In this case, when command ‘$echo 2000000’ among the commands is changed to ‘$echo 3000000’, the maximum memory usage may be restricted to 3 MB.

In one example of the implementation of the present disclosure, the container-based cloud server 1000 may control the network in each container by using application iptables. The iptables as one of Linux user programs may be allowed to control the network of the system by installing specific rules for the network by using framework netfilter of the Linux kernel. That is, the iptables may perform various desired actions by dividing packets according to various criteria such as a packet content (e.g., TCP port) according to a protocol and thus may serve as a network packet filter or a firewall. The command (program) iptables may actually have, for example, the following format:

“$ iptables -I INPUT -s 198.51.100.0 -j DROP”

An example of the command may refer to a command to add a rule to block all packets received from a host having an IP address of 198.51.100.0 to 10. Specifically, for each option, “-I INPUT” means that the rule corresponding to the command is added to a beginning part of a chain (firstly applied) and “-s [ip address] means that the corresponding IP address is made to correspond to a packet having a source address, and last, “-j DROP” represents a substantial action to filter and drop the packet at the time of receiving the corresponding packet. As other command options, there are “-p, --protocol” to select only a packet corresponding to a specific protocol, “-d, --destination” to select a packet based on a destination address, and “-i, --interface” to select only a specific network interface and set the selected network interface as a target. In the present disclosure, a special option which may correspond only to the specific protocol is used for implementing port control, in addition to a basic options: “--destination-port” assists serving to block a specific port as an option that may be applied when TCP or UDP is selected with the option “-p”. By setting the rule using the command iptables as described above, the cloud server 1000 according to an exemplary embodiment of the present disclosure may control the network which is one of assets of the system. The description of the network control of the cloud server 1000 is just an example and the present disclosure is not limited thereto.

According to the container based cloud server monitoring method of one embodiment of the present disclosure, monitoring of the computing devices included in the system may be performed. The resource of the system can be distributed through the resource monitoring of the computing device, the usability of the system can be improved, and the performance of the system can be maintained through the monitoring of abnormal behavior. The performance of each of the computing devices in the system can be improved by efficiently managing resources and monitoring abnormal behavior through monitoring of the system including the computing device.

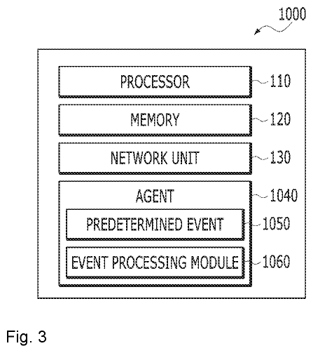

FIG. 3 is a block diagram of container-based cloud servers 1000 according to an exemplary embodiment of the present disclosure.

Components of the container-based cloud server 1000 illustrated in FIG. 3 are exemplary. Only some of the components illustrated in FIG. 3 may constitute the container-based cloud server 1000. Further, an additional component(s) may be included in the container-based cloud server 1000 in addition to the components illustrated in FIG. 3.

As illustrated in FIG. 3, the container-based cloud server 1000 may include a processor 110, a memory 120, a network unit 130, and an agent 1040 driven by the processor.

The processor 110 may perform operations for monitoring the respective container operating in the container-based cloud server 1000. Further, the processor 110 may perform operations for controlling the plurality of container of the container-based cloud server 1000. In addition, the memory 120 may store program codes executable in the processor 110. Specifically, the memory 120 may store program codes for the processor 110 to monitor and control the plurality of containers. Further, the network unit 130 may transmit and receive data to and from the management server 2000. In this case, the data transmitted to the management server 2000 may include the static resource information and the container information and the data received from the management server 2000 may be at least one of request information and control information.

According to an exemplary embodiment of the present disclosure, the processor 110 may control the agent 1040 to perform monitoring and control operations for the plurality of containers. In this case, the agent 1040 may be located in the host OS of the container-based cloud server 1000. Hereinafter, a specific method in which the processor 110 performs the monitoring operation and the control operation for the plurality of containers by controlling the agent 1040 will be described.

According to an exemplary embodiment of the present disclosure, the processor 110 may control the operation of the agent 1040. Specifically, the processor 110 may cause the agent 1040 to perform the monitoring operation of the static resource information from the host OS 1002. In this case, the static resource information may include basic information for constructing the container-based cloud server 1000. Specifically, the static resource information may include information on hardware, software, and the network constructing the container-based cloud server 1000. For example, the information on the hardware may include information on at least one of the CPU, the memory, a disk, a LAN card, a graphics card, and a monitor. For example, the information on the network may include at least one of Host name information, Interface name information, MAC address information, Netmask information, gateway information, and DNS information. The concrete description of the static resource information is only an example and the present disclosure is not limited thereto.

Further, the processor 110 may cause the agent 1040 to perform the monitoring operation of the container information from the host OS 1002. The container information may include dynamic resource information and basic container information. In this case, the dynamic resource information as information on a resource that changes in real time may include information on a resource usage of each of the plurality of containers connected to the OS 1002 and a resource remaining amount of the cloud server. Specifically, the dynamic resource information may be information on a change amount of a resource used for driving an application in the plurality of containers. For example, the dynamic resource information may include information on a utilization rate and a usage time of a CPU, a memory, a hard disk, or a network, which are changed when a user of the container-based cloud server operates the application. In addition, the basic container information may include at least one of information on an application operation for each container and information on the operation of the user. Specifically, the basic container information may include information that the application executed in at least one container among the plurality of containers connected to the host OS 1002 is changed based on at least one of an installation action, a deletion action, and a removal deletion of the user. As a specific example, the basic container information may include information that the application is changed by at least one of the installation action, the deletion action, a change action, a connection action, a release action, and an access action of the user for a file, a program, a process, a device, a network and a shared directory operated in the application. The information included in the static resource information, the dynamic resource information, and the basic container information is only an example and the present disclosure is not limited thereto.

Accordingly, under the control of the processor 110, the agent 1040 may perform at least one of a static resource monitoring operation and a container information monitoring operation.

According to an exemplary embodiment of the present disclosure, the processor 110 may determine whether a predetermined event 1050 occurs.

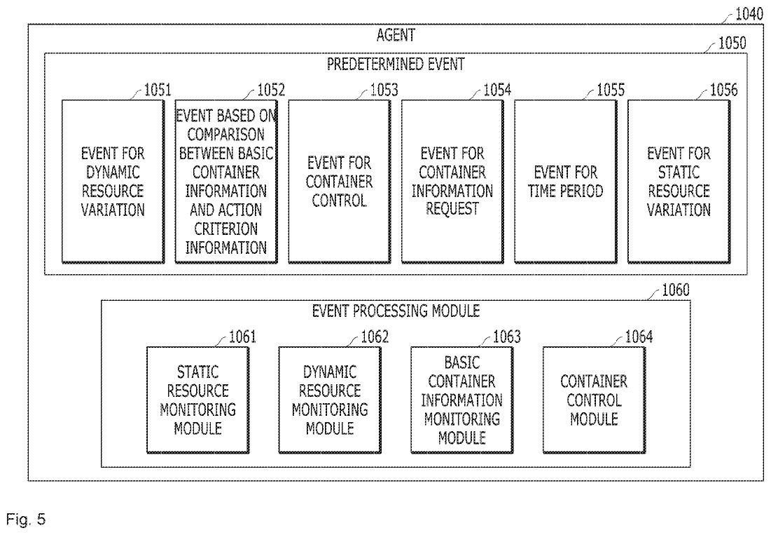

As illustrated in FIG. 5, the predetermined event 1050 may include at least one of an event 1051 for dynamic resource variation, an event 1052 based on a comparison of the basic container information and action criterion information, an event 1053 for container control, an event 1054 for a container information request, an event 1055 for a time period, and an event 1056 for static resource variation. The specific description of the above-mentioned event is only an example and the event in the present disclosure may include a predetermined event that necessitates monitoring for the container.

The event 1051 for the dynamic resource variation may be an event in which the resource usage of each of the plurality of containers connected to the host OS 1002 may vary. For example, the event 1051 for the dynamic resource variation may include creating a new container in the container-based cloud server 1000, driving an application in the container, and the like. As another example, the event 1051 may be resource variation which deviates from a resource usage threshold preset by an administrator of the container-based cloud server 1000. Specifically, when the administrator presets a usage of the CPU driven in the plurality of containers to 70%, the processor 110 may determine whether the event 1051 for the dynamic resource variation occurs by using the agent 1040 with respect to a case where a usage of the CPU exceeds 70%. The event 1051 for the dynamic resource variation described above is only an example and the present disclosure is not limited thereto.

The event 1052 based on the comparison of the basic container information and the action criterion information may be an event regarding whether the user using the container-based cloud server 1000 violates predetermined action criterion information. Specifically, the event 1052 based on the comparison of the basic container information and the action criterion information may be an event regarding whether the user performs a restricted action in the container-based cloud server 1000 by comparing the action criterion information set by the administrator of the cloud server based on the restriction of the user action and the basic container information monitored and collected from the agent 1040. For example, the restricted action of the user of the container-based cloud server 1000 may at least one of a modification and/or deletion action of important files of the container-based cloud server 1000, a forced termination action of important programs and/or processes, and a connection action of external devices (USB, smart phone, Bluetooth, DVD device, etc.). The restricted action of the user is just an example and the present disclosure is not limited thereto.

According to an exemplary embodiment of the present disclosure, the basic container information and the action criterion information are compared with each other and when the user of the container-based cloud server 1000 performs the restriction action included in the action criterion information, the processor 110 may determine that the event 1052 based on the comparison between the basic container information and the action criterion information occurs. For example, the action criterion information may be a restriction for a particular program installation of a plurality of users of the container-based cloud server 1000 set by the administrator. In this case, when a specific program installation operation restricted by the administrator is monitored in the basic container information which the processor of the container-based cloud server 1000 monitors through the agent 1040, the processor 110 may determine that the event 1052 occurs based on the comparison between the basic container information and the action criterion information by using the agent 1040. The action criterion information generated by the restriction by the administrator is just an example and the present disclosure is not limited thereto.

The event 1053 for the container control may be an event for controlling the plurality of containers connected to the container-based cloud server 1000. Specifically, the event for the container control may be an event for controlling at least one of the user, the program, the network, and the device of the container in which an abnormal action occurs in the plurality of containers. Further, the event 1053 for the container control may be created based on the control information received from the management server 2000. When receiving the control information from the management server 2000, the processor 110 may determine that the event 1053 for the container control occurs. For example, when receiving from the management server control information to completely interrupt that an application operating in the container receives a packet from a host having a specific IP address, the processor 110 may determine that the event 1053 for the container control occurs by using the agent 1040. The control information is just an example and the present disclosure is not limited thereto.

The event 1054 for the container information request may be an event related to the request of the administrator for the container information including the dynamic resource information and the basic container information. Specifically, the event for the container information request may be an event for the administrator to request the container-based cloud server 1000 for at least one of the dynamic resource information and the basic container information to observe the plurality of containers. When the container-based cloud server 1000 receives the request information generated and transmitted from the management server 2000 by the administrator, the processor 110 may determine that the event 1054 for the container information request occurs by using the agent 1040.

The event 1055 for the time period may be an event which occurs every predetermined time period which is repeated. Specifically, the event 1055 for the time period may be an event which occurs according to a time period preset by the administrator through the management server 2000. The processor 110 may determine that the event for the time period occurs according to the predetermined time period. For example, when the administrator sets the time period to monitor the static resource information once every 24 hours through the management server 2000, the processor may determine that the time period event occurs every 24 hours set using the agent 1040. The specific time period is just an example and the present disclosure is not limited thereto.

The event 1056 for the static resource variation may be an event for variation of basic information for constructing the container-based cloud server 1000. That is, the event 1056 for the static resource variation may be generated based on the variation of the static resource information. The static resource information refers to a fixed resource that does not change until the computer is restarted. For example, the static resource information may include hardware information such as a CPU, a RAM (memory), a graphics card, and a network card and software information. Thus, the static resource information may be varied by re-mounting of hardware. That is, the event 1056 for the static resource variation may occur by hardware changes of the CPU, the RAM, the graphics card, and network card. In addition, the event for the static resource variation may occur by a software change such as a version change of software installed in the cloud server.

According to an exemplary embodiment of the present disclosure, the memory 120 may store information on the program code, monitoring, and system control executable in the processor 110. For example, the memory 120 may store information related to the predetermined event 1050 and the event processing module 1060 corresponding to the request information and the control information received from the management server 2000.

According to an exemplary embodiment of the present disclosure, the network unit 130 may transmit and receive information to and from the management server 2000. More specifically, the network unit 160 may include a wired/wireless Internet module for network access. As the wireless Internet technology, wireless LAN (WLAN) (Wi-Fi), wireless broadband (Wibro), world interoperability for microwave access (Wimax), high speed downlink packet access (HSDPA), or the like, may be used. As wired Internet technology, a digital subscriber line (XDSL), fibers to the home (FTTH), power line communication (PLC), or the like may be used.

The network unit 130 may be positioned at a comparatively short distance from the user terminal including a short range communication module and transmit and receive data to and from an electronic apparatus including the short range communication module. As short-range communication technology, Bluetooth, radio frequency identification (RFID), infrared data association (IrDA), ultra wideband (UWB), ZigBee, or the like may be used.

According to an exemplary embodiment of the present disclosure, the agent 1040 may process the predetermined event 1050 under the control of the processor 110. Specifically, the agent 1040 may process the predetermined event 1050 by driving the plurality of event processing modules 1060 under the control of the processor 110. In this case, the event processing module 1060 corresponding to the predetermined event 1050 may be driven under the control of the processor 110.

According to an exemplary embodiment of the present disclosure, the agent 1040 may include the plurality of event processing modules 1060, as illustrated in FIG. 5. The plurality of event processing modules 1060 may include at least one of a static resource monitoring module 1061, a dynamic resource monitoring module 1062, a basic container information monitoring module 1063, and a container control module 1064.

According to an exemplary embodiment of the present disclosure, the static resource monitoring module 1061 may be driven based on control of the processor 110 when an event related to static resource monitoring occurs. The event related to the static resource monitoring may include the event for the time period and the event (e.g., hardware replacement, etc.) regarding the static resource variation. In this case, the processor 110 may drive the static resource monitoring module 1061 corresponding to the time period event among the plurality of event processing modules 1060. Further, when the static resource monitoring module 1061 is driven, the processor 110 may collect the static resource information from the host OS and perform an operation of allowing the collected static resource information to be transmitted to the management server 2000.

According to an exemplary embodiment of the present disclosure, the dynamic resource monitoring module 1062 may be driven based on the control of the processor 110 when at least one of the event 1051 for the dynamic resource variation, the event 1054 for the container information request, and the event 1055 for the time period occurs. Further, when the dynamic resource monitoring module 1062 is driven, the processor 110 may collect the dynamic resource information of at least one container of the plurality of containers connected to the host OS and perform an operation of allowing the collected dynamic resource information to be transmitted to the management server 2000.

According to an exemplary embodiment of the present disclosure, the basic container information monitoring module 1063 may be driven based on the control of the processor 110 when at least one of the event 1052 based on the comparison between the basic container information and the action criterion information, the event 1054 for the container information request, and the event 1055 for the time period occurs. Further, when the basic container information monitoring module 1063 is driven, the processor 110 may collect the basic container information from at least one container of the plurality of containers connected to the host OS 1002 and perform an operation of allowing the collected basic container information to be transmitted to the management server 2000.

According to an exemplary embodiment of the present disclosure, the container control module 1064 may be driven based on the control of the processor 110 when at least one of the event 1053 for the container control and the event 1055 for the time period occurs. When the container control module 1064 is driven, the processor 110 may perform at least one control operation among a plurality of control operations with respect to at least one container among the plurality of containers connected to the host OS 1002. Here, the plurality of control operations may include at least one of the device control operation, the file control operation, the program control operation, the process control operation, and the network control operation. The device control operation as an operation for controlling a device connected to the user terminal using the container-based cloud server 1000 may include at least one of a USB connection control, a smart phone connection control, a Bluetooth device control, an FDD device control, a DVD device control, an infrared control, a printer control, and a port control, for example. The file control operation as an operation for controlling files and directories executed in the user terminal using the container-based cloud server 1000 may include at least one of random file and arbitrary directory deletion prevention, forced file and directory deletion and file access blocking, file modification restriction, and isolation and storage depending on importance of the file, for example. The program control operation as an operation for controlling a program executed in the user terminal using the container-based cloud server 1000 may include at least one of random program removal prevention, unauthorized program forced removal, and unauthorized program pre-installation blocking, for example. The process control operation as an operation for controlling a service and a process executed in the user terminal using the container-based cloud server 1000 may include at least one of arbitrary process termination prevention, forced process termination, and process execution restriction, for example. The network control operation as an operation for controlling the network of the user terminal using the container-based cloud server 1000 may include, for example, network connection blocking, port opening restriction, blacklist IP blocking, blacklist domain blocking, AP connection blocking, and HTTP protocol blocking.

The device control operation, the file control operation, the process control operation, and the network control operation are merely examples and the present disclosure is not limited thereto.

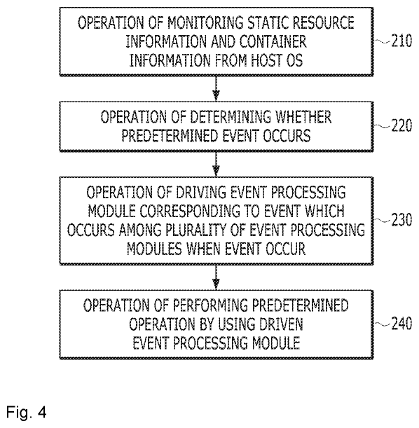

FIG. 4 is a flowchart of an operation for processors 110 of container-based cloud servers 1000 to monitor respective containers according to an exemplary embodiment of the present disclosure.

According to an exemplary embodiment of the present disclosure, the container-based cloud server 1000 may monitor the static resource information and the container information from the host OS 1002 (210). Specifically, the container-based cloud server 1000 may monitor the static resource information and the container information of each of the plurality of containers connected to the host OS 1002 through the agent 1040 installed in the host OS 1002. In this case, the static resource information may include basic information for constructing the container-based cloud server 1000.

The container information may include dynamic resource information and basic container information. In this case, the dynamic resource information as information on a resource that changes in real time may include information on a resource usage of each of the plurality of containers connected to the host OS and a resource remaining amount of the cloud server. Specifically, the dynamic resource information may be information on a change amount of a resource used for driving an application in the plurality of containers.

The basic container information may include at least one of information on an application operation for each container and information on the operation of the user. Specifically, the basic container information may include information that the application executed in at least one container among the plurality of containers connected to the host OS 1002 is changed based on at least one of an installation action, a deletion action, and a removal action of the user. As a specific example, the basic container information may include information that the application is changed by at least one of the installation action, the deletion action, a change action, a connection action, a release action, and an access action of the user for a file, a program, a process, a device, a network and a shared directory operated in the application.

According to an exemplary embodiment of the present disclosure, the container-based cloud server 1000 may perform an operation of determining whether the predetermined event 1050 occurs (220). The predetermined event 1050 may include at least one of an event 1051 for dynamic resource variation, an event 1052 based on a comparison of the basic container information and action criterion information, an event 1053 for container control, an event 1054 for a container information request, and an event 1055 for a time period.

The event 1051 for the dynamic resource variation may be an event for resource usage variation of each of the plurality of containers connected to the host OS. Specifically, the event 1051 for the dynamic resource variation may be a resource variation occurring in at least one of the plurality of containers. For example, the event 1051 for the dynamic resource variation may be creation of a new container in the container-based cloud server 1000. As another example, the event 1051 may be resource variation which deviates from a resource usage threshold preset by an administrator of the container-based cloud server 1000. Specifically, when the administrator presets a usage of the CPU driven in the plurality of containers to 70%, the cloud-based cloud server 1000 may determine whether the event 1051 for the dynamic resource variation occurs with respect to a resource usage in which a usage of the CPU exceeds 70%. The event 1051 for the dynamic resource variation described above is only an example and the present disclosure is not limited thereto.

The event 1052 based on the comparison of the basic container information and the action criterion information may be an event regarding whether the user using the container-based cloud server 1000 violates predetermined action criterion information. Specifically, the event 1052 based on the comparison of the basic container information and the action criterion information may be an event regarding monitoring the user who performs a restricted action in the container-based cloud server 1000 by comparing the action criterion information generated based on the restriction on the user action set by the administrator and the basic container information monitored and collected from the agent 1040. The basic container information and the action criterion information are compared with each other and when the user of the container-based cloud server 1000 performs the restriction action included in the action criterion information, the processor 110 may determine that the event 1052 based on the comparison between the basic container information and the action criterion information occurs. For example, the administrator may generate the action criterion information to restrict a particular program installation operation of a plurality of users of the container-based cloud server 1000. In this case, when a specific program installation operation restricted by the administrator is monitored in the basic container information which the container-based cloud server 1000 monitors, the processor 110 may determine that the event 1052 based on the comparison between the basic container information and the action criterion information occurs. The action criterion information generated by the restriction by the administrator is just an example and the present disclosure is not limited thereto.

The event 1053 for the container control may be an event for controlling the plurality of containers connected to the container-based cloud server. Specifically, the event for the container control may be an event for controlling at least one of the user, the program, the network, and the device of the container in which an abnormal action occurs in the plurality of containers. Further, the event 1053 for the container control may be created based on the control information received from the management server 2000. When receiving the control information from the management server 2000, the processor 110 may determine that the event 1053 for the container control occurs. For example, when receiving from the management server 2000 control information to block all packets from a host having a specific IP address, the container-based cloud server 1000 may determine that the event 1053 for the container control occurs. The control information is just an example and the present disclosure is not limited thereto.

The event 1054 for the container information request may be an event related to the request of the administrator for the container information including the dynamic resource information and the basic container information. Specifically, the event for the container information request may be an event for the administrator to request the container-based cloud server 1000 for at least one of the dynamic resource information and the basic container information to manage the plurality of containers. When the administrator generates and transmits request information through the management server 2000 and the container-based cloud server 1000 receives the request information, the container-based cloud server 1000 may determine that the event 1054 for the container information request occurs. In this case, the request information may be determined by selection by the administrator through the management server 2000.

The event 1055 for the time period may be an event which occurs every predetermined time period which is repeated. Specifically, the event 1055 for the time period may be an event which occurs according to a time period preset by the administrator through the management server 2000. The processor 110 may determine that the event for the time period occurs according to the predetermined time period. For example, when the administrator sets the time period to monitor the static resource information once every 24 hours through the management server 2000, the container-based cloud server 1000 may determine that the time period event occurs every set 24 hours. The specific time period is just an example and the present disclosure is not limited thereto.

According to an exemplary embodiment of the present disclosure, when the event occurs, the container-based cloud server 1000 may perform an operation of driving the event processing module corresponding to the occurring event among the plurality of event processing modules 1060 (230).

The container-based cloud server 1000 may operate the dynamic resource monitoring module 1062 of the plurality of event processing modules 1060 when the dynamic resource variation event occurs.

The container-based cloud server 1000 may operate the basic container information monitoring module 1063 among the plurality of event processing modules 1060 when the event based on the comparison between the basic container information and the action criterion information.

The container-based cloud server 1000 may operate the container control module 1064 of the plurality of event processing modules 1060 when the event for the container control occurs.

The container-based cloud server 1000 may operate at least one of the dynamic resource monitoring module 1062 and the basic container information monitoring module 1063 among the plurality of event processing modules 1060 when the event for the container information request occurs.

The container-based cloud server 1000 may operate at least one of the static resource monitoring module 1061, the dynamic resource monitoring module 1062, and the basic container information monitoring module 1063 when the event for the time period occurs.

According to an exemplary embodiment of the present disclosure, the container-based cloud server 1000 may perform a predetermined operation by the driven processing module (240).

According to an exemplary embodiment of the present disclosure, the static resource monitoring module 1061 may be driven based on the control of the processor 110 when the time period event occurs. In this case, the processor 110 may drive the static resource monitoring module 1061 corresponding to the time period event among the plurality of event processing modules 1060. Further, when the static resource monitoring module 1061 is driven, the static resource monitoring module 1061 may collect the static resource information from the host OS 1002 and perform an operation of transmitting the collected static resource information to the management server 2000.

According to an exemplary embodiment of the present disclosure, the dynamic resource monitoring module 1062 may be driven based on the control of the processor 110 when at least one of the event 1051 for the dynamic resource variation, the event 1054 for the container information request, and the event 1055 for the time period occurs. Further, when the dynamic resource monitoring module 1062 is driven, the dynamic resource monitoring module 1062 may collect the dynamic resource information of at least one container of the plurality of containers connected to the host OS 1002 and perform an operation of transmitting the collected dynamic resource information to the management server 2000.

According to an exemplary embodiment of the present disclosure, the basic container information monitoring module 1063 may be driven based on the control of the processor 110 when at least one of the event 1052 based on the comparison between the basic container information and the action criterion information, the event 1054 for the container information request, and the event 1055 for the time period occurs. Further, when the basic container information monitoring module 1063 is driven, the basic container information monitoring module 1063 may collect the basic container information from at least one container of the plurality of containers connected to the host OS 1002 and perform an operation of transmitting the collected basic container information to the management server 2000.

According to an exemplary embodiment of the present disclosure, the container control module 1064 may be driven based on the control of the processor 110 when at least one of the event 1053 for the container control and the event 1055 for the time period occurs. Further, when the container control module 1064 is driven, the container control module 1064 may perform at least one control operation among a plurality of control operations with respect to at least one container among the plurality of containers connected to the host OS 1020.

The plurality of control operations may include at least one of the device control operation, the file control operation, the program control operation, the process control operation, and the network control operation.

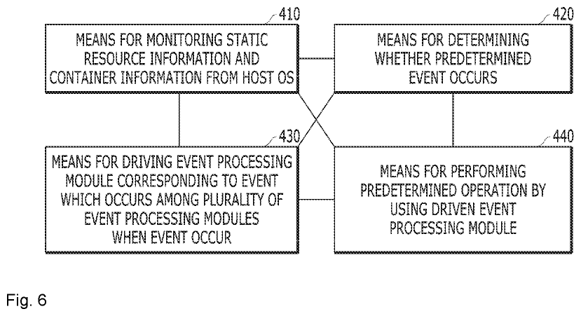

FIG. 6 is a diagram illustrating a means for monitoring respective containers which operate in container-based cloud servers 1000 according to an exemplary embodiment of the present disclosure.

According to an exemplary embodiment of the present disclosure, the container-based cloud server 1000 may include a means 410 for monitoring static resource information and container information from a host OS 1020 to monitor each container, a means 420 for determining whether a predetermined event 1050 occurs, a means 430 for driving an event processing module corresponding to an event occurring among a plurality of event processing modules when an event occurs, and a means 440 for performing a predetermined operation by using the driven event processing module.

Alternatively, the static resource information may include basic information for constructing the container-based cloud server 1000.

Alternatively, the container information may include dynamic resource information and basic container information, and the dynamic resource information may include information on a resource usage for each of a plurality of containers and a resource remaining amount of the cloud server as information on a resource which is changed in real time and the basic container information may include at least one of information on an application operation for each container among the plurality of containers and information on the operation of the user.

Alternatively, the plurality of event processing modules 1060 may include at least one of a static resource monitoring module 1061, a dynamic resource monitoring module 1062, a basic container information monitoring module 1063, and a container control module 1064.

Alternatively, the predetermined event 1050 may include at least one of an event 1051 for dynamic resource variation, an event 1052 based on a comparison of the basic container information and action criterion information, an event 1053 for container control, an event 1054 for a container information request, and an event 1055 for a time period.

Alternatively, the event 1051 for the dynamic resource variation may be an event related to a resource usage variation of each of the plurality of containers, and when the dynamic resource variation occurs, the processor 110 may operate the dynamic resource monitoring module 1062 and the dynamic resource monitoring module 1062 may perform operations of collecting dynamic resource information of at least one container among the plurality of containers connected to the host OS, and transmitting the collected dynamic resource information to the management server.

Alternatively, the event 1052 based on the comparison of the basic container information and the action criterion information is an event regarding whether the user of the container-based cloud server 1000 violates the predetermined action criterion information and the processor 110 may operate the basic container information monitoring module 1063 based on the comparison between the action criterion information received from the management server 2000 and the basic container information and the basic container information monitoring module 1063 may perform operations of collecting the basic container information of at least one container among the plurality of containers connected to the host OS 1002 and transmitting the collected basic container information to the management server 2000.

Alternatively, the event 1053 for the container control is an event for controlling the plurality of containers connected to the container-based cloud server 1000 and is generated based on the control information received from the management server 2000 and the processor 110 may operate the container control module 1064 when receiving the control information from the management server 2000 and the container control module 1064 may perform at least one operation of a device control operation, a file control operation, a program control operation, a process control operation, and a network control operation of at least one container among the plurality of containers connected to the host OS 1002.

Alternatively, the event 1054 for the container information request is an event related to the request of the administrator for the container information and the processor 110 may operate at least one module of the dynamic resource monitoring module 1062 and the basic container information monitoring module 1063 when receiving the request information from the management server.

Alternatively, the event 1055 for the time period is an event that occurs at a predetermined time period that is repeated and the processor 110 may operate at least one module of the static resource monitoring module 1061, the dynamic resource monitoring module 1062, the basic container information monitoring module 1063, and the container control module 1064 according to the predetermined time period.

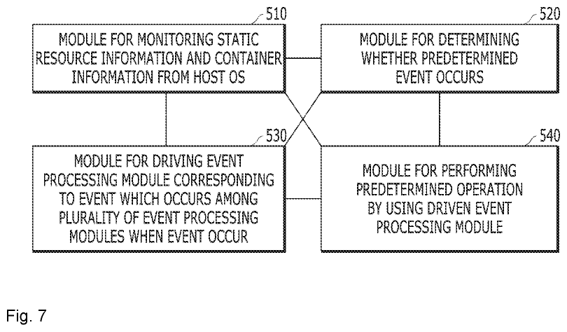

FIG. 7 is a diagram illustrating modules for monitoring respective containers which operate in container-based cloud servers 1000 according to an exemplary embodiment of the present disclosure.

A method for monitoring the respective containers operating in the container-based cloud server 1000 according to an exemplary embodiment of the present disclosure may be implemented by modules described below.

According to an exemplary embodiment of the present disclosure, the container-based cloud server 1000 may include a module 510 for monitoring static resource information and container information from a host OS 1002 to monitor each container, a module 520 for determining whether a predetermined event occurs, a module 530 for driving an event processing module corresponding to an event occurring among a plurality of event processing modules when an event occurs, and a module 540 for performing a predetermined operation by using the driven event processing module.

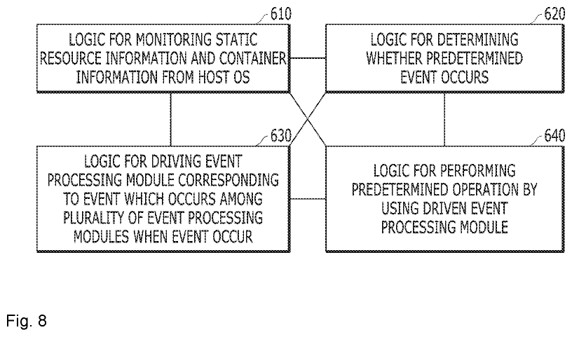

FIG. 8 is a diagram illustrating logics for monitoring respective containers which operate in container-based cloud servers 1000 according to an exemplary embodiment of the present disclosure.

A method for monitoring the respective containers operating in the container-based cloud server 1000 according to an exemplary embodiment of the present disclosure may be implemented by logics described below.

According to an exemplary embodiment of the present disclosure, the container-based cloud server 1000 may include a logic 610 for monitoring static resource information and container information from a host OS 1002 to monitor each container, a logic 620 for determining whether a predetermined event 1050 occurs, a logic 630 for driving an event processing module 1060 corresponding to an event occurring among a plurality of event processing modules when an event occurs, and a logic 640 for performing a predetermined operation by using the driven event processing module 1060.

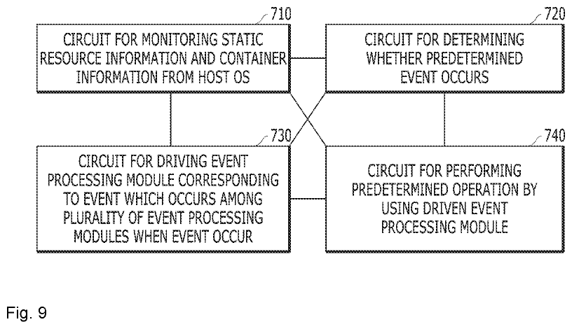

FIG. 9 is a diagram illustrating circuits for monitoring respective containers which operate in container-based cloud servers 1000 according to an exemplary embodiment of the present disclosure.

A method for monitoring the respective containers operating in the container-based cloud server according to an exemplary embodiment of the present disclosure may be implemented by circuits described below.

According to an exemplary embodiment of the present disclosure, the container-based cloud server 1000 may include a circuit 710 for monitoring static resource information and container information from a host OS 1002 to monitor each container, a circuit 720 for determining whether a predetermined event 1050 occurs, a circuit 730 for driving an event processing module 1060 corresponding to an event occurring among a plurality of event processing modules 1060 when an event occurs, and a circuit 740 for performing a predetermined operation by using the driven event processing module 1060.

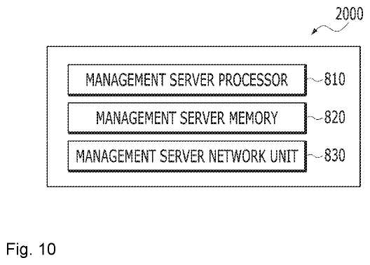

FIG. 10 is a block diagram of a management server 2000 according to an exemplary embodiment of the present disclosure.

Components of the management server 2000 illustrated in FIG. 10 are exemplary. Only some of the components may constitute the management server 2000. Further, an additional component(s) may be included in the management server 2000 in addition to the components.

As illustrated in FIG. 10, the management server 2000 may include a management server processor 810, a management server memory 820, and a management server network unit 830.

According to an exemplary embodiment of the present disclosure, the management server processor 810 may generate integrated information that integrates the static resource information and container information received from the container-based cloud server 1000 and generate the user interface for integrated management including observation of the resource usage of the container-based cloud server 1000 and control for the container-based cloud server 1000 based on the generated integrated information.

According to an exemplary embodiment of the present disclosure, the management server processor 810 may perform an operation of receiving the static resource information and container information from the container-based cloud server 1000.

According to an exemplary embodiment of the present disclosure, the management server processor 810 integrates the static resource information and container information received from the container-based cloud server 1000 to generate the integrated information. That is, the management server processor 810 may control to generate integrated information including basic information (that is, configuration information) for the container-based cloud server 1000, information on a dynamic resource and the user action, and the like.

According to an exemplary embodiment of the present disclosure, the management server processor 810 may generate the user interface to be provided to the external computing device 3000 based on the integrated information. Specifically, the management server processor 810 may generate the user interface based on the integrated information including the configuration information for the container-based cloud server 1000, the information on the resource usage, and the information on the user action. The user interface is provided to the external computing device to allow the administrator to facilitate management of the cloud server 1000.

According to an exemplary embodiment of the present disclosure, the management server processor 810 may generate request information based on setting of the administrator for the container-based cloud server 1000. The request information may be information related to a request of the administrator for acquiring container information of the container-based cloud server 1000. Specifically, the request information may be generated based on a request from the administrator for at least one of dynamic resource information and basic container information included in the container information of the container-based cloud server 1000. In addition, the management server processor 810 may decide to transmit the generated request information to the container-based cloud server 1000. For example, when the administrator wants the dynamic resource information of the container-based cloud server 1000, the management server processor 810 may generate the request information based on the dynamic resource information based on the input of the administrator and decide to transmit the generated request information to the container-based cloud server 1000.

According to an exemplary embodiment of the present disclosure, the management server processor 810 may generate control information based on the setting of the administrator for the container-based cloud server 1000. In this case, the control information may include at least one of a plurality of control operations for controlling the container-based cloud server 1000. The plurality of control operations may include at least one of the device control operation, the file control operation, the program control operation, the process control operation, and the network control operation.

The device control operation as an operation for controlling a device connected to a terminal of a user using the container-based cloud server 1000 may include at least one of a USB connection control, a smart phone connection control, a Bluetooth device control, an FDD device control, a DVD device control, an infrared control, a printer control, and a port control, for example.

The file control operation as an operation for controlling files and directories executed in the user terminal using the container-based cloud server 1000 may include at least one of random file and directory deletion prevention, forced file and directory deletion and file access blocking, file modification restriction, and isolation and storage depending on importance of the file, for example.

The program control operation as an operation for controlling a program executed in a user terminal using the container-based cloud server 1000 may include at least one of random program removal prevention, unauthorized program forced removal, and unauthorized program pre-installation blocking, for example.

The process control operation as an operation for controlling a service and a process executed in the user terminal using the container-based cloud server 1000 may include at least one of arbitrary process termination prevention, forced process termination, and process execution restriction, for example.

The network control operation as an operation for controlling the network of the user terminal using the container-based cloud server 1000 may include, for example, network connection blocking, port opening restriction, blacklist IP blocking, blacklist domain blocking, AP connection blocking, and HTTP protocol blocking.

The device control operation, the file control operation, the process control operation, and the network control operation are merely examples and the present disclosure is not limited thereto.

According to an exemplary embodiment of the present disclosure, the management server processor 810 may decide to transmit the generated control information to the container-based cloud server 1000. For example, when the administrator wants a network connection blocking operation for a specific user using the container-based cloud server 1000, the management server processor 810 may generate the control information based on the network control operation and decide to transmit the generated request information to the container-based cloud server 1000.

According to an exemplary embodiment of the present disclosure, the management server memory 820 may store a program code executable in the management server processor 810 and information on user interface generation provided to the external computing device 3000.

According to an exemplary embodiment of the present disclosure, the management server network unit 830 may transmit and receive information to and from the contained-based cloud server 1000 and the external computing device 3000. More specifically, the management server network unit 830 may include a wired/wireless Internet module for network access. As the wireless Internet technology, wireless LAN (WLAN) (Wi-Fi), wireless broadband (Wibro), world interoperability for microwave access (Wimax), high speed downlink packet access (HSDPA), or the like, may be used. As wired Internet technology, a digital subscriber line (XDSL), fibers to the home (FTTH), power line communication (PLC), or the like may be used.

The management server network unit 830 may include a short range communication module and may be positioned at a comparatively short distance from the user terminal 200 transmit and receive data to and from an electronic apparatus including the short range communication module. As short-range communication technology, Bluetooth, radio frequency identification (RFID), infrared data association (IrDA), ultra wideband (UWB), ZigBee, or the like may be used.

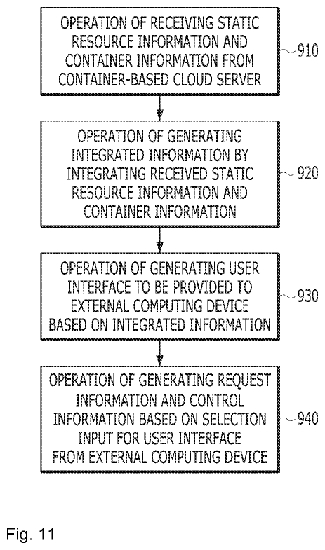

FIG. 11 is a flowchart of an operation of a management server processor 810 included in a management server 2000, for integratedly managing container-based cloud servers 1000 according to an exemplary embodiment of the present disclosure.

According to an exemplary embodiment of the present disclosure, the management server 2000 may perform an operation of receiving static resource information and container information from the container-based cloud server 1000 (910).

According to an exemplary embodiment of the present disclosure, the management server 2000 may perform an operation of integrating the received static resource information and container information and generating integrated information (920). The management server 2000 may generate integrated information including configuration information for the container-based cloud server 1000, information on a resource usage, and information on a user action.

According to an exemplary embodiment of the present disclosure, the management server 2000 may perform an operation of generating a user interface to be provided to the external computing device 3000 based on the integrated information (930). Specifically, the management server 2000 may generate the user interface based on the integrated information including the configuration information for the container-based cloud server 1000, the information on the resource usage, and the information on the user action. In addition, the management server 2000 may generate the user interface to be provided to the external computing device 3000, including information on an importance of events occurring in the container-based cloud server. Further, the management server 2000 may generate the user interface provided to the external computing device 3000, including information on the resource usage for each time zone of each container of the container-based cloud server 1000.

According to an exemplary embodiment of the present disclosure, the management server 2000 may perform an operation of generating request information and control information based on a selection input for the user interface from the external computing device 3000 (940).

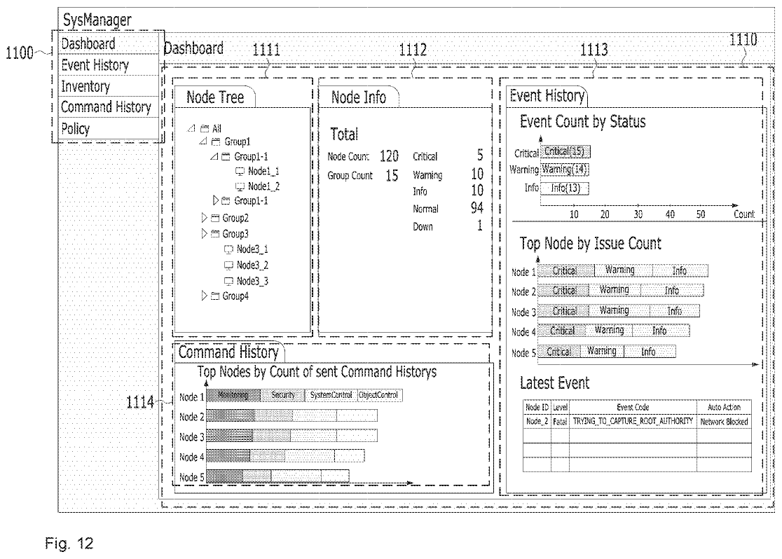

FIG. 12 is an exemplary view of a Dashboard user interface which a management server 2000 provides to an external computing device 3000 according to an exemplary embodiment of the present disclosure.

According to one embodiment of the present disclosure, the user interface may be generated based on the integrated information. In this case, the integrated information may include the configuration information for the container-based cloud server 1000, the information on the resource usage, and the information on the user action.

According to an exemplary embodiment of the present disclosure, the user interface may include at least one of a Dashboard user interface, an Event History user interface, an Inventory user interface, a Command History user interface, and a Policy user interface (reference numeral 1100). Concrete items indicated by reference numeral 1100 are just examples and the present disclosure is not limited thereto.

The Dashboard user interface may be a user interface that provides an administrator with the convenience so as to centrally manage and search various information of the container-based cloud server 1000 on one screen. The Dashboard user interface (reference numeral 1110) includes partial information of an Event History user interface (reference numeral 1113), Inventory user interfaces (reference numerals 1111 and 1112), and a Command History user interface (reference numeral 1114) to be provided to the administrator. Accordingly, the administrator may easily observe information on the container-based cloud server 1000 at a glance through the Dashboard user interface.

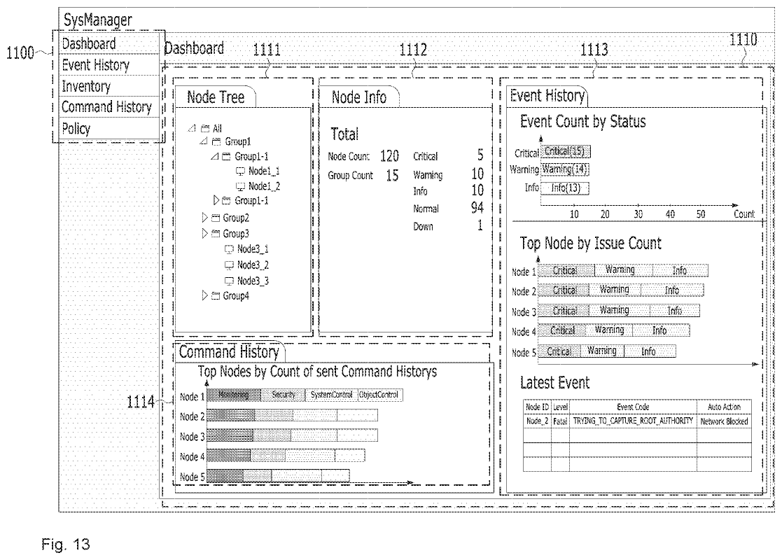

FIG. 13 is an exemplary view of an Event History user interface which the management server 2000 provides to the external computing device 3000 according to an exemplary embodiment of the present disclosure.

The Event History user interface may be a user interface for providing the administrator with information on an event occurring in the container-based cloud server 1000. Specifically, the Event History user interface may be provided to the administrator including a summary of the status of nodes according to the importance of events generated by the container-based cloud server 1000 and the number of events according to the importance of events. Further, the Event History user interface means information including all of a plurality of events generated in the container-based cloud server 1000 and the Event History user interface may be configured in a graph form so as for the administrator to easily observe the generated events or configured in a list in which the events are arranged in an occurrence order. In addition, when the administrator selectively inputs the events to be arranged and displayed, detailed information for the event that occurs may be displayed.

Referring to FIG. 13, the detailed information may be expressed as Fatal 10, Critical 12, Warning 30, and Information 50, as shown in a region of reference numeral 1210. That is, the Event History user interface may express the events which occur in the container-based cloud server 1000 in the graph form based on the importance (reference numeral 1210). In this case, the importance of the event may be determined based on the action of the user set by the administrator. For example, when the management server 2000 sets the importance of the event which occurs due to an action of the user of the container-based cloud server 1000, who deletes a specific file to be fatal based on the setting of the administrator, the importance of the corresponding event may be determined to be high in the case where the corresponding event occurs.

The Event History user interface may search the plurality of events which occurs in the container-based cloud server 1000 and provide the searched events to the administrator. In this case, the plurality of events may be searched based on at least one of the code of the event, the importance of the event, and a security level (reference numeral 1220). In this case, the event code may be an action of the user using the container-based cloud server 1000. For example, the event code may be at least one action of a modification and/or deletion action of a specific file, a forced termination action of a specific program and/or process, and a connection action of an external device (USB, smart phone, Bluetooth, DVD device, etc.). The event code for the action of the user is just an example and the present disclosure is not limited thereto. Further, the security level may be classified based on each container of the container-based cloud server 1000. That is, the security level may vary for each container of the container-based cloud server 1000. In this case, the security level may be classified based on an application that drives each container. For example, when an application that requires a higher security environment construction is driven in the container, the security level may be increased correspondingly. Further, the security level may be indicated as at least one of High, Normal, and Low.

The Event History user interface may arrange and provide the plurality of events so as for the administrator to easily see the plurality of events (reference numeral 1230). In this case, the plurality of arranged events may be displayed based on the selection input of the user for at least one o f the code of the event, the importance of the event, and the security level. Further, the Event History user interface may provide detailed information of the event to the administrator based on the selection input of the administrator for the plurality of events. Specifically, when the administrator selects and inputs an event to check the detailed information among the plurality of events, the Event History user interface may display detailed information of the event selectively input by the administrator and provide the detailed information to the administrator (reference numeral 1240). In this case, the detailed information as information on a container which causes the corresponding event to occur in the container-based cloud server 1000 may include information on at least one of a node ID, host name, node type, event level, an event occurrence time, and user action information. The concrete information of the detailed information is only an example and the present disclosure is not limited thereto.

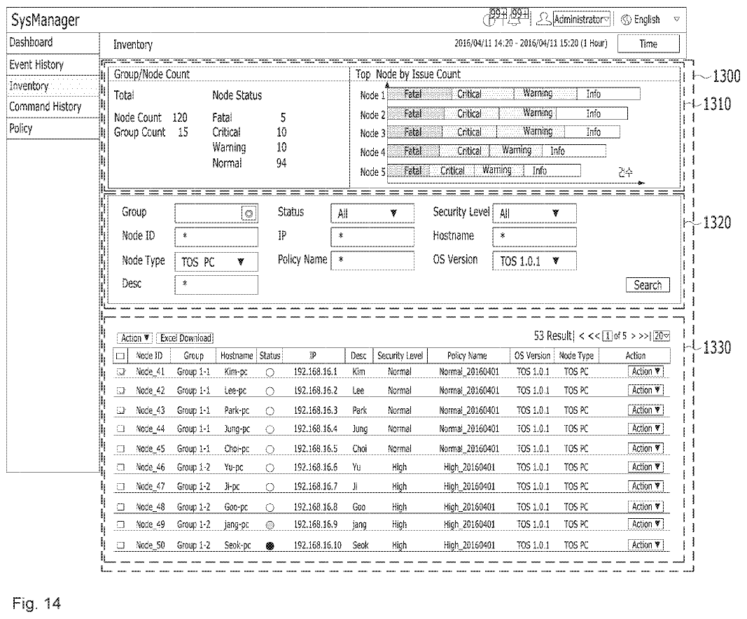

FIG. 14 is an exemplary view of an Inventory user interface which the management server 2000 provides to the external computing device 3000 according to an exemplary embodiment of the present disclosure.

The Inventory user interface may be a user interface providing list information of each node (container) of the container-based cloud server 1000 to the administrator. Specifically, the Inventory user interface may display information on each container connected to the container-based cloud server 1000 integratedly managed by the management server 2000 (reference numeral 1300). Referring to FIG. 14, the Inventory user interface may display the number of respective nodes of the container-based cloud server 1000 and the number of groups in which a plurality of nodes are grouped, as shown in the area of reference numeral 1310. Further, the Inventory user interface may display the number of nodes for each level according to the importance of events occurring in each node of the container-based cloud server 1000. As a specific example, as shown in reference area 1310, 5 nodes in which a fatal event occurs, 10 nodes in which a critical event occurs, 10 nodes in which a warning event occurs, and 94 nodes which are in normal state may be displayed.

The Inventory user interface may perform a search for each node of the container-based cloud server 1000. Specifically, the Inventory user interface may perform a search for a specific node of a plurality of nodes (a plurality of containers) connected to the container-based cloud server 1000 (reference numeral 1320). Further, the Inventory user interface may perform a search for at least one group among a plurality of groups connected to the container-based cloud server 1000. In this case, the plurality of groups may be generated through grouping of the plurality of nodes.

The Inventory user interface may arrange and provide a plurality of pieces of information based on the selection input of the administrator for the specific node (reference numeral 1330). In this case, the plurality of pieces of information may include node ID, Group, Hostname, Status, IP, Desc, Security level, policy name, OS version, Node Type, and Action as shown in the area of reference numeral 1330. The plurality of pieces of arranged information is just an example and the present disclosure is not limited thereto. More specifically, when the administrator makes the selection input to at least one of the plurality of nodes and the plurality of groups, the Inventory user interface may arrange and display the information based on the selection of the administrator. For example, when the administrator performs the selection input for Group 1 (reference numeral 1320), the Inventory user interface may arrange information for a plurality of users using Group 1 selected and input by the administrator and display the information as shown in the area of reference numeral 1330.

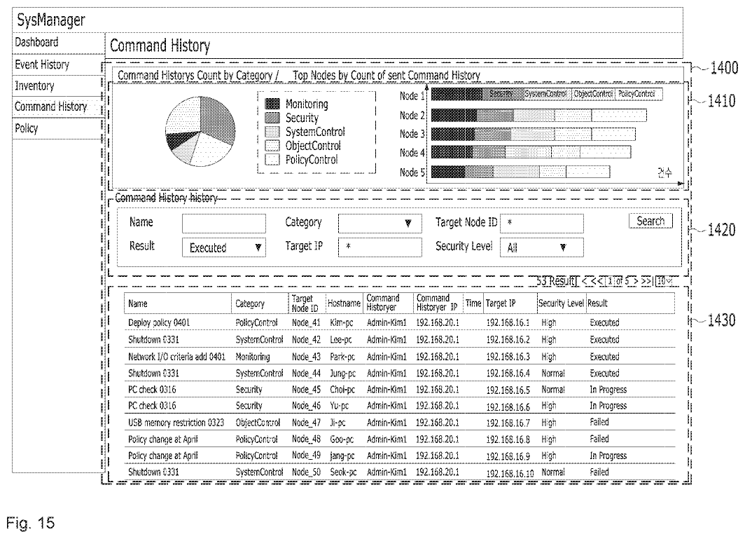

FIG. 15 is an exemplary view of a Command History user interface which the management server 2000 provides to the external computing device 3000 according to an exemplary embodiment of the present disclosure.

The Command History user interface may be a user interface in which the management server 2000 provides the administrator with a history list of information acquired by monitoring the container-based cloud server 1000 and control information to perform integrated management. Specifically, the Command History user interface may provide information about requests and information about control used for the management server 2000 to integratedly manage the container-based cloud server 1000 (reference numeral 1400). For example, the Command History user interface may indicate the number of control information transmitted to the management server 2000 in order to request monitoring of the container-based cloud server 1000 or to control the container. Further, the Command History user interface may be displayed in the graph form like the area of reference numeral 1410 based on the number of times of receiving dynamic resource monitoring information received from the container-based cloud server 1000, the number of times of receiving basic container information monitoring, the number of times of performing a control operation, and the number of times of changing control information.

The Command History user interface may provide a screen for searching request information and control information transmitted to the container-based cloud server 1000 from the administrator, as shown in the area of reference numeral 1420. In this case, the request information and the control information may be searched based on the selection input of the administrator for at least one of name of information, category of information, target node ID, execution result, and security level in Target IP.

As shown in reference area 1430, the Command History user interface may arrange and display specific request information and specific control information based on the selection input of the administrator among the request information and the control information transmitted to the container-based cloud server.

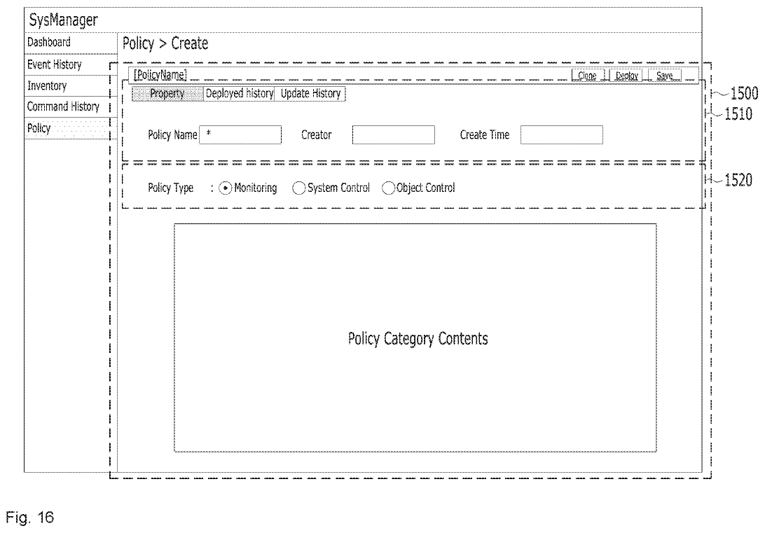

FIG. 16 is an exemplary view of a Policy user interface which the management server 2000 provides to the external computing device 3000 according to an exemplary embodiment of the present disclosure.

A Policy user interface may be a user interface for generating request information and control information for the administrator to observe and control the container-based cloud server 1000. The Policy user interface may provide a screen for receiving the selection input from the administrator based on at least one of the request information and the control information (reference numeral 1500). Further, the request information and the control information may be generated based on the selection input of the administrator for the screen.

The Policy user interface may provide a screen for inputting Policy Name, Creator, and Create Time from the administrator (reference numeral 1510). In this case, the Policy Name as a name of control which the administrator registers at the time of creating a new control action for defining the container-based cloud server 1000 may be displayed to be prepared by the administrator in association with an action of the administrator for controlling the plurality of containers of the container-based cloud server 1000 (reference numeral 1510). Further, Creator in the area of reference numeral 1510 may receive input regarding the name of the administrator who generates the control action for defining the container-based cloud server 1000 and the request for observing the container-based cloud server 1000. Further, Creator time may provide the screen for the administrator to receive an input for a time of generating the control action for defining the container-based cloud server 1000 and the request for observing the container-based cloud server 1000 (reference numeral 1510).

The Policy user interface may provide the administrator with a selection screen for generating control information for controlling the container of the container-based cloud server 1000 and request information for monitoring the container-based cloud server 1000. Specifically, the selection screen provided by the Policy user interface to the administrator may include Monitoring, System Control, and Object Control (reference numeral 1520). In this case, when the administrator makes the selection input for monitoring on the screen provided by the Policy user interface, request information may be generated to receive container information of each container of the container-based cloud server 1000. Further, when the administrator makes the selection input for system control on the screen provided by the Policy user interface, control information may be generated to perform at least one of file control, program control, process control, and network control of the container-based cloud server 1000. In this case, the file control operation as an operation for controlling files and directories executed in the user terminal using the container-based cloud server 1000 may include at least one of random file and directory deletion prevention, forced file and directory deletion and file access blocking, file modification restriction, and isolation and storage depending on importance of the file, for example. The program control operation as an operation for controlling a program executed in a user terminal using the container-based cloud server 1000 may include at least one of random program removal prevention, forced unauthorized program removal, and unauthorized program pre-installation blocking, for example. The process control operation as an operation for controlling a service and a process executed in the user terminal using the container-based cloud server 1000 may include at least one of arbitrary process termination prevention, forced process termination, and process execution restriction, for example. The network control operation as an operation for controlling the network of the user terminal using the container-based cloud server 1000 may include, for example, network connection blocking, port opening restriction, blacklist IP blocking, blacklist domain blocking, AP connection blocking, and HTTP protocol blocking. In addition, when the administrator makes a selection input for object control on a screen provided by the Policy user interface, control information may be generated to control a device connected to the user terminal using the container-based cloud server 1000. For example, the operation of the controlling the device may include at least one control operation of USB connection control, smart phone connection control, Bluetooth device control, FDD device control, DVD device control, infrared control, printer control, and port control.

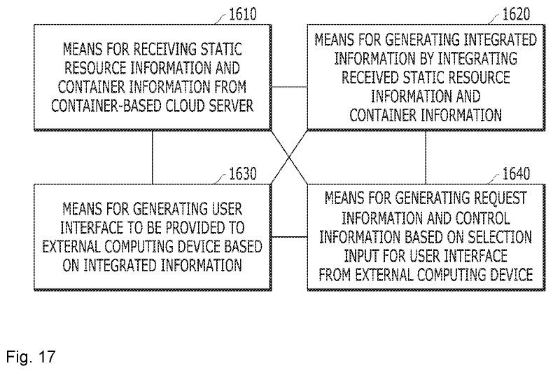

FIG. 17 is a diagram illustrating means for a management server processor 810 included in a management server 2000 to integratedly manage container-based cloud servers 1000 according to an exemplary embodiment of the present disclosure.

According to an exemplary embodiment of the present disclosure, the means for integratedly managing the container-based cloud server 1000 may include a means 1610 for receiving static resource information and container information from the container-based cloud server 1000; a means 1620 for generating integrated information by integrating the received static resource information and container information; a means 1630 for generating a user interface to be provided to an external computing device 3000 based on the integrated information; and a means 1640 for generating request information and control information based on a selection input of the user interface from the external computing device 3000.

Alternatively, the means for integrally managing the container-based cloud server 1000 may further include a means for deciding to transmit the request information and the control information to the container-based cloud server (1000).

Alternatively, the request information may be information on a request of the administrator for the container-based cloud server 1000 and a request for at least one information of dynamic resource information and basic container information.

Alternatively, the control information as information for controlling the container-based cloud server 1000 itself may be generated by the setting of the administrator.

Alternatively, the user interface may be additionally provided to the external computing device 3000, including information on the importance of events occurring in the container-based cloud server 1000 and may be provided to the external computing device 3000, including information on a resource usage for ach time zone of each container of the container-based cloud server 1000.

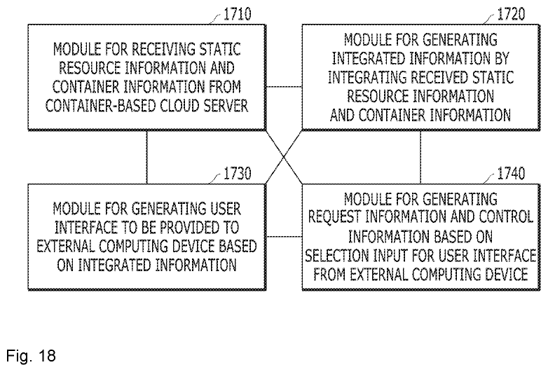

FIG. 18 is a diagram illustrating modules for the management server processor 810 included in the management server 2000 to integratedly manage the container-based cloud servers 1000 according to an exemplary embodiment of the present disclosure.

According to an exemplary embodiment of the present disclosure, the module for integratedly managing the container-based cloud server 1000 may include a module 1710 for receiving static resource information and container information from the container-based cloud server 1000; a module 1720 for generating integrated information by integrating the received static resource information and container information; a module 1730 for generating a user interface to be provided to an external computing device 3000 based on the integrated information; and a module 1740 for generating request information and control information based on a selection input of the user interface from the external computing device 3000.

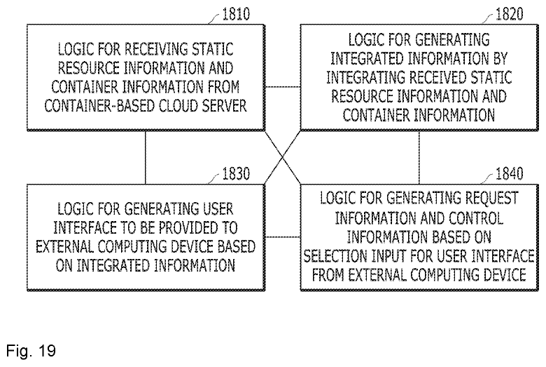

FIG. 19 is a diagram illustrating a logic for the management server processor 810 included in the management server 2000 to integratedly manage the container-based cloud servers 1000 according to an exemplary embodiment of the present disclosure.

According to an exemplary embodiment of the present disclosure, the logic for integratedly managing the container-based cloud server 1000 may include a logic 1810 for receiving static resource information and container information from the container-based cloud server 1000; a logic 1820 for generating integrated information by integrating the received static resource information and container information; a logic 1830 for generating a user interface to be provided to an external computing device 3000 based on the integrated information; and a logic 1840 for generating request information and control information based on a selection input of the user interface from the external computing device 3000.

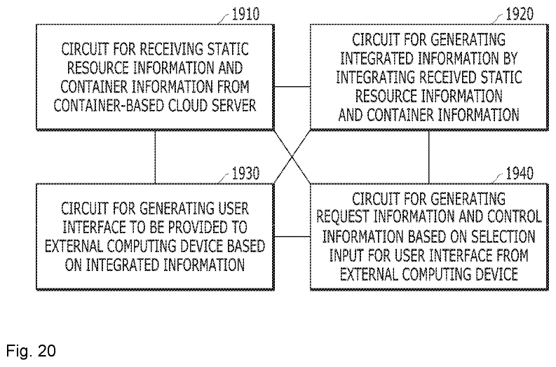

FIG. 20 is a diagram illustrating a circuit for a management server processor 810 included in a management server 2000 to integratedly manage container-based cloud servers 1000 according to an exemplary embodiment of the present disclosure.

According to an exemplary embodiment of the present disclosure, the circuit for integratedly managing the container-based cloud server 1000 may include a circuit 1910 for receiving static resource information and container information from the container-based cloud server 1000; a circuit 1920 for generating integrated information by integrating the received static resource information and container information; a circuit 1930 for generating a user interface to be provided to an external computing device 3000 based on the integrated information; and a circuit 1940 for generating request information and control information based on a selection input of the user interface from the external computing device 3000.

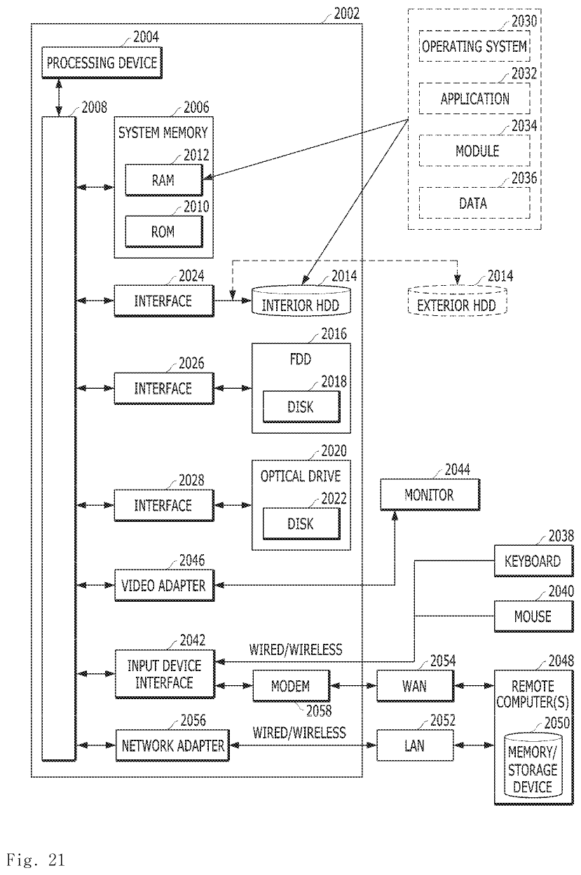

FIG. 21 is a simple and general schematic view of an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary or non-temporary media, and movable and non-movable media implemented by a predetermined method or technology for storing information such as a computer readable command, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2000 is shown and the computer 2002 includes a processing device 2004, a system memory 2006, and a system bus 2008. The system bus 2008 connects system components including the system memory 2006 (not limited thereto) to the processing device 2004. The processing device 2004 may be a predetermined processor among various commercial processors. A dual processor or other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (for example, EIDE and SATA)—the internal hard disk drive (HDD) 2014 may also be configured for an external purpose in an appropriate chassis (not illustrated)—, a magnetic floppy disk drive (FDD) 2016 (for example, for reading from or writing in a mobile diskette 2018), and an optical disk drive 2020 (for example, for reading a CD-ROM disk 2022 or reading from or writing in other high-capacity optical media such as the DVD). The hard disk drive 2014, the magnetic disk drive 2016, and the optical disk drive 2020 may be connected to the system bus 2008 by a hard disk drive interface 2024, a magnetic disk drive interface 2026, and an optical drive interface 2028, respectively. An interface 2024 for implementing an external drive includes, for example, at least one of a universal serial bus (USB) and an IEEE 1394 interface technology or both of them.

The drives and the computer readable media associated therewith provide non-volatile storage of the data, the data structure, the computer executable command, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached by the RAM 2012. It will be well appreciated that the present disclosure may be implemented in operating systems which are commercially usable or a combination of the operating systems.

A user may input commands and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058 or may be connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that illustrated network connection is exemplary and other means configuring a communication link among computers may be used.

The computer 1602 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

Those skilled in the art of the present disclosure will appreciate that various exemplary logic blocks, modules, processors, means, circuits, and algorithm steps described in association with the embodiments disclosed herein can be implemented by electronic hardware, various types of programs or design codes (designated as “software” herein for easy description), or a combination of all thereof. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer-readable device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” include a wireless channel and various other media that can store, possess, and/or transfer command(s) and/or data, but are not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be analyzed within the widest range which is coherent with the principles and new features presented herein.

What is claimed is:

1. A computer program stored in a computer-readable storage medium, including encoded commands, which causes one or more processors to perform operations for monitoring respective containers operating in a container-based cloud server when the computer program is executed by the one or more processors of a computer system, wherein the operations comprise:
an operation of monitoring static resource information from a host OS;
an operation of monitoring container information of each of a plurality of containers from the host OS;
an operation of determining whether a predetermined event occurs;
an operation of driving an event processing module corresponding to an event which occurs among a plurality of event processing modules when an event occurs based on the determination as to whether the event occurs; and
an operation of performing a predetermined operation by using the driven event processing module.

2. The computer program of claim 1, wherein the static resource information includes basic information for constructing the container-based cloud server.

3. The computer program of claim 1, wherein the container information includes dynamic resource information and basic container information,
the dynamic resource information as information on a resource that changes in real time includes information on a resource usage of each of the plurality of containers connected and a resource remaining amount of the cloud server, and
the basic container information includes at least one of information on an application operation for each container among the plurality of containers and information on the operation of a user.

4. The computer program of claim 1, wherein the plurality of event processing modules includes at least one of a static resource monitoring module, a dynamic resource monitoring module, a basic information monitoring module, and a container control module.

5. The computer program of claim 1, wherein the predetermined event includes at least one of an event for dynamic resource variation, an event based on a comparison of the basic container information and action criterion information, an event for container control, an event for a container information request, and an event for a time period.

6. The computer program of claim 5, wherein the event for the dynamic resource variation is an event regarding resource usage variation of each of the plurality of containers,
the processor operates a dynamic resource monitoring module when the dynamic resource variation occurs, and
the dynamic resource monitoring module collects dynamic resource information of at least one container of the plurality of containers connected to the host OS and performs an operation of transmitting the collected dynamic resource information to a management server.

7. The computer program of claim 5, wherein the event based on the comparison of the basic container information and the action criterion information is an event regarding whether the user using the container-based cloud server violates predetermined action criterion information,
the processor operates a basic container information monitoring module based on the comparison between the action criterion information received from the management server and the basic container information, and
the basic container information monitoring module collects the basic container information of at least one of the plurality of containers connected to the host OS and performs an operation of transmitting the collected basic container information to the management server.

8. The computer program of claim 5, wherein the event for the container control is an event for controlling the plurality of containers connected to the container-based cloud server and is generated based on control information received from the management server,
the processor operates a container control module when receiving the control information from the management server, and
the container control module performs at least one of a device control operation, a file control operation, a program control operation, a process control operation, and a network control operation of at least one of the plurality of containers connected to the host OS.

9. The computer program of claim 5, wherein the event for the container information request is an event regarding a request of an administrator for the container information, and
the processor operates at least one of a dynamic resource monitoring module and a basic container information monitoring module when receiving request information from the management server.

10. The computer program of claim 5, wherein the event for the time period is an event which occurs at a predetermined time period which is repeated, and
the processor operates at least one of the static resource monitoring module, the dynamic resource monitoring module, the basic container information monitoring module, and the container control module according to a predetermined time period.

11. A method for monitoring respective containers operating in a container-based cloud server, the method comprising:
monitoring static resource information from a host OS;
monitoring container information of each of a plurality of containers from the host OS;
determining whether a predetermined event occurs;
driving an event processing module corresponding to an event which occurs among a plurality of event processing modules when an event occurs based on the determination as to whether the event occurs; and
performing a predetermined operation by using the driven event processing module.

12. A container-based cloud server comprising:
a processor including one or more cores;
a memory storing program codes executed by the processor; and
a network unit transmitting/receiving data to/from a management server,
wherein the processor performs operations for monitoring respective containers operating in the container-based cloud server, in which the operations include
an operation of monitoring static resource information from a host OS,
an operation of monitoring container information of each of a plurality of containers from the host OS,
an operation of determining whether a predetermined event occurs,
an operation of driving an event processing module corresponding to an event which occurs among a plurality of event processing modules when an event occurs based on the determination as to whether the event occurs, and
an operation of performing a predetermined operation by using the driven event processing module.

13. A computer program stored in a computer-readable storage medium, including encoded commands, which causes one or more processors to perform the following operations for integratedly managing a container-based cloud server when the computer program is executed by the one or more processors of a computer system, wherein the operations comprise:
an operation of receiving static resource information and container information from the container-based cloud server;
an operation of generating integrated information by integrating the received static resource information and container information;
an operation of generating a user interface to be provided to an external computing device based on the integrated information; and
an operation of generating request information and control information based on a selection input for the user interface from the external computing device.

14. The computer program of claim 13, wherein the operation for integratedly managing the container-based cloud server further includes an operation of deciding to transmit the request information and the control information to the container-based cloud server.

15. The computer program of claim 13, wherein the request information is information on a request of an administrator for the container-based cloud server and a request for at least one information of dynamic resource information and basic container information.

16. The computer program of claim 13, wherein the control information is information for controlling the container-based cloud server and is generated by setting of the administrator.

17. The computer program of claim 13, wherein the user interface is additionally provided to the external computing device, including information on an importance of an event which occurs in the container-based cloud server and provided to the external computing device, including information on a resource usage for each time zone of each container of the container-based cloud server.

18. A method for integratedly managing a container-based cloud server, the method comprising:
receiving static resource information and container information from the container-based cloud server;
generating integrated information by integrating the received static resource information and container information;
generating a user interface to be provided to an external computing device based on the integrated information; and
generating request information and control information based on a selection input for the user interface from the external computing device.

19. A management server providing an integrated management service, comprising:
a management server processor including one or more cores;
a management server memory storing program codes executed by the processor; and
a management server network unit transmitting/receiving data to/from a container-based cloud server and an external computing device,
wherein the processor performs operations for integratedly managing the container-based cloud server, in which the operations include
an operation of receiving static resource information and container information from the container-based cloud server;
an operation of generating integrated information by integrating the received static resource information and container information;
an operation of generating a user interface to be provided to an external computing device based on the integrated information; and
an operation of generating request information and control information based on a selection input for the user interface from the external computing device.
